(19) United States
(12) Patent Application Publication
(10) Pub. No.: US 2008/0070030 A1
(43) Pub. Date: Mar. 20, 2008

(54) Static dissipative articles

(75) Inventors: Jimmie R. Baran, Prescott, WI (US); Duane D. Fansler, Dresser, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/521,844

(22) Filed: Sep. 15, 2006

(51) Int. Cl. B32B 5/16; B05D 3/02

(52) U.S. Cl. 428/323; 428/328; 427/384

(57) ABSTRACT

The present disclosure discloses a static dissipative article having a coating. The coating comprises a surface-functionalized nanoparticle component having quaternary amine groups on the surface of the nanoparticle, and a binder in which the nanoparticles are dispersed.

### FIELD

The present invention relates to a static dissipative article.

### BACKGROUND

Electrostatic charge buildup is responsible for a variety of problems in the processing and use of many industrial products and materials. Electrostatic charging can cause materials to stick together or to repel one another. This is a particular problem in fiber and textile processing. In addition, static charge buildup can cause objects to attract dirt and dust, which can lead to fabrication or soiling problems and can impair product performance.

Increasing the electrical conductivity of a material can control static charge buildup. This can be accomplished by increasing ionic or electronic conductivity. The most common means of controlling static accumulation today is by increasing electrical conductivity through moisture adsorption. This is commonly achieved by adding moisture to the surrounding air (humidification) or by use of hygroscopic antistatic agents, which are generally referred to as humectants since they rely on the adsorption of atmospheric moisture for their effectiveness. Most antistatic agents operate by dissipating static charge as it builds up; thus, static decay rate and surface conductivity are common measures of the effectiveness of antistatic agents. U.S. Pat. No. 6,372,829 (Lamanna et. al.) and U.S. Pat. No. 6,395,149 (Palmgren) further describe antistatic agents and compositions, herein incorporated by reference.

Antistatic agents can be applied to the surface (external antistat) or incorporated into the bulk (internal antistat) of an otherwise insulating material as described in Horvath, T. and Berta, I., Static Elimination. Electrostatic Application and Electrostatic Application Series, pp. 24-26 (Research Studies Press, Letchworth, England, 1982). Internal antistats are commonly employed in polymers such as plastics. Generally, internal antistats are mixed directly into a molten polymer during melt processing, such as molding, melt blowing, melt spinning, and melt extrusion. Antistat agents used for external and internal applications include quaternary ammonium salts, and halide or methanesulfonate salts.

### SUMMARY

The present disclosure is directed to a static dissipative article comprising a substrate having a coating. The coating comprises a surface-functionalized nanoparticle component having quaternary amine groups on the surface of the nanoparticles. In one aspect, the coating further comprises a binder in which the nanoparticles are dispersed. The quaternary amine groups are present on the surface of the nanoparticle in a quantity sufficient to render the article static dissipative. The quaternary amine groups present on the surface of the nanoparticle are sufficient to form a monolayer of coverage to less than a monolayer of coverage.

The surface of the nanoparticles having quaternary amine groups may further comprise a mixture of amines. The amines on the surface of the nanoparticle may include primary amines, secondary amines and tertiary amine groups.

In another aspect of the disclosure, a coating composition comprises a surface-functionalized nanoparticle component having quaternary amine groups on the surface of the nanoparticles. The nanoparticle component is dispersed in a binder, where the coating composition may further comprise a solvent. The nanoparticles of the coating composition are essentially free of agglomeration.

In another aspect of the disclosure, a method for making a static dissipative article is described. The method comprises a substrate, a coating composition comprising a surface-functionalized nanoparticle component having quaternary amine groups on the surface of the nanoparticles, where the nanoparticles are dispersed in a binder. Further, the coating can be applied to the substrate, and cured. The cured coating thickness may be less than 100 μm to still render the substrate static dissipative.

In another aspect of the disclosure, a method for applying a coating is described. The coating comprises a surface-functionalized nanoparticle component having quaternary amine groups on the surface of the nanoparticles dispersed in a binder. The coating can be applied to the substrate, and cured.

External or internal antistat agents suffer from limited thermal stability and hygroscopic characteristics. These agents, used as additives, may be applied to a surface coating, or incorporated in the bulk of a material. However, these agents, which are typically small molecules, can migrate to the surface providing antistatic properties, but may be readily abraded or washed away without maintaining antistatic properties throughout the coating.

Many low molecular weight, neutral antistats have sufficiently high vapor pressures, and insufficient thermal stability, that are unsuitable for use at elevated temperatures, as in polymer melt processing, due to material losses that occur via evaporation. Antistatic agents or antistats can migrate or bloom to the surface of a coating or substrate as a result of high vapor pressure, incompatibility and other component interactions. Nonmetallic antistatic agents are humectants that rely on the adsorption and conductivity of water for charge dissipation. These agents are water soluble, and are easily removed by exposure to water, thus providing for a lack of durability.

In this disclosure, quaternary amine groups are covalently bound to a nanoparticle, thus reducing small molecule migration and blooming in a coating. The nanoparticles of the coating composition have bulk antistatic properties in contrast to coatings containing small molecule antistats, due to the dispersibility of the nanoparticles throughout the coating. Further, the inorganic nanoparticles have quaternary amine groups on the surface, where the nanoparticles are insoluble in water and other solvents, and are processable at elevated temperatures.

In another aspect, the static dissipative article of this disclosure has a coating having nanoparticles comprising quaternary amine groups covalently bonded to its surface dispersed in a binder. The surface modified nanoparticles are used as additives in coatings to provide antistatic properties. The additives are dispersed throughout the coating on the article, where the nanoparticles provide a high surface area sufficient for monolayer quaternary amine group coverage or less than a monolayer coverage.

The nanoparticles with quaternary amine groups, as functionalized nanoparticles, may have a concentration of less than 25 weight percent, and more preferably less than 10 weight percent in the coating composition sufficient to achieve antistatic properties.

In another aspect, the concentration of the binder with solvent in the coating composition is at least 20 weight percent.

In another aspect, the nanoparticles are dispersed as antistatic additives in a binder and/or solvent. In addition to being readily dispersible in aqueous coatings, the nanoparticles are capable of being used in transparent coatings. The term “transparent” is defined as having the property of transmitting light without appreciably scattering light so that bodies lying beyond may be seen clearly. The nanoparticle diameter is smaller than the length of visible light, where the nanoparticles have an average particle diameter less than 100 nm.

The above summary of the present disclosure is not intended to describe each disclosed embodiment or every implementation of the present disclosure. The figures and the detailed description which follow, more particularly exemplify illustrative embodiments.

### DETAILED DESCRIPTION

For the following defined terms, these definitions shall be applied, unless a different definition is given in the claims or elsewhere in the specification The term “alkylamine” is defined as an analog of ammonia (NH₃), in which either one, two, or three hydrogen atoms of ammonia are replaced by organic radicals. General formulas are: (1) primary amines, —N(R¹R²), where R¹ and R² are both H; (2) secondary amines, —N(R¹R³), where R¹ is H and R³ is an alkyl group; and (3) tertiary amines, —N(R³)₂, where R³ is an alkyl group. The alkyl group attachment is merely a representative example of one group that may be attached to the N of the amine groups.

The term “curing” is defined as the toughening or hardening of a polymer material by cross-linking of polymer chains, brought about by chemical additives, ultraviolet radiation, Electron Beam (EB), actinic radiation, or heat. “Curing” may further include the removal of solvent or solvents from a coating to facilitate hardening or toughening without cross-linking.

The term “nanoparticle” as used herein (unless an individual context specifically implies otherwise) will generally refer to particles, groups of particles, particulate molecules (i.e., small individual groups or loosely associated groups of molecules) and groups of particulate molecules that while potentially varied in specific geometric shape have an effective, or average, diameter that can be measured on a nanoscale (i.e., less than about 100 nanometers).

The term, “one-pot synthesis” is a method to improve the efficiency of a chemical reaction, whereby a reactant or reactants is subjected to successive chemical reactions in just one reactor. This strategy avoids an extended separation process and purification of the intermediate chemical compounds, saving both time and resources while increasing the chemical yield.

The terms “particle diameter” and “particle size” are defined as the maximum cross-sectional dimension of a particle. If the particle is present in the form of an aggregate, the terms, “particle diameter” and “particle size” refer to the maximum cross-sectional dimension of the aggregate.

The term “quaternary amine” group is defined as —N(R³)₃⁺Z⁻, where N is cationic, Z represents an anion or counterion to the cationic N, and each R³ is an alkyl group. The alkyl group attachment is merely a representative example of one group that may be attached to the N of the amine groups. The amine group is functionalized so as to form a cationic species.

The term “surface-modified nanoparticle” or “surface-functionalized nanoparticle” is defined as a particle that includes surface groups attached to the surface of the particle. The surface groups modify the character of the particle sufficient to form a monolayer, desirably a continuous monolayer, or less than a monolayer on the surface of a nanoparticle.

The term “conductive material” is defined as those having a surface resistivity less than 1×10⁵ Ω/sq, or a volume resistivity less than 1×10⁴ Ωcm. With a low electrical resistance, electrons flow easily across the surface or through the bulk of these materials. Charges go to ground or to another conductive object that the material contacts or comes close to as referenced in “ESD Association Advisory for Electrostatic Discharge Terminology”, ESE-ADV 1.0-1994 (Electrostatic Discharge Association, Rome, N.Y.).

The term “dissipative material” is defined as having a surface resistivity equal to or greater than 1×10⁵ Ω/sq, but less than 1×10¹² Ω/sq or a volume resistivity equal to or greater than 1×10⁴ Ω-cm, but less than 1×10¹¹ Ω-cm. For these materials, the charges flow to ground more slowly and in a somewhat more controlled manner than with conductive materials as referenced in “ESD Association Advisory for Electrostatic Discharge Terminology”, ESE-ADV 1.0-1994 (Electrostatic Discharge Association, Rome, N.Y.).

The term “insulative material” is defined as those having a surface resistivity of at least 1×10¹² Ω/sq or a volume resistivity of at least 1×10¹¹ Ω-cm. Insulative materials prevent or limit the flow of electrons across their surface or through their volume. Insulative materials have a high electrical resistance and are difficult to ground. Static charges remain in place on these materials for a very longtime as referenced in “ESD Association Advisory for Electrostatic Discharge Terminology”, ESE-ADV 1.0-1994 (Electrostatic Discharge Association, Rome, N.Y.).

The term “antistatic material” is not defined by resistance or resistivity. Antistatic refers to the property of a material that inhibits triboelectric charging. A materials antistatic characteristic is not necessarily correlated with its resistivity or resistance as referenced in “ESD Association Advisory for Electrostatic Discharge Terminology”, ESE-ADV 1.0-1994 (Electrostatic Discharge Association, Rome, N.Y.).

The term “surface resistivity” is defined as the resistance measured on the surface of a material. Electrodes are placed on the surface of a material, a voltage is applied, and the resistance between the electrodes is measured.

The term “volume resistivity” is defined as the resistance measured through the bulk, or volume, or a material. Electrodes are placed on the upper and lower surfaces of a material, a voltage is applied, and the resistance between the electrodes is measured.

The recitation of numerical ranges by endpoints includes all numbers subsumed within that range (e.g., 1 to 5 includes 1, 1.5, 2, 2.75, 3, 3.80, 4, and 5).

As included in this specification and the appended claims, the singular forms a “an”, and “the” include plural referents unless the content clearly dictates otherwise. Thus, for example, reference to a composition containing “a compound” includes a mixture of two or more compounds. As used in this specification and appended claims, the term “or” is generally employed in its sense including “and/or” unless the content clearly dictates otherwise.

Unless otherwise indicated, all numbers expressing quantities or ingredients, measurement of properties and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present disclosure. At the very least, and not as an attempt to limit the application of the doctrine of equivalents to the scope of the claims, each numerical parameter should at least be construed in light of the number of reported significant digits and by applying ordinary rounding techniques. Not withstanding that the numerical ranges and parameters setting forth the broad scope of the disclosure are approximations, their numerical values set forth in the specific examples are reported as precisely as possible. Any numerical value, however, inherently contains errors necessarily resulting from the standard deviations found in their respective testing measurement.

This disclosure describes a static dissipative article. The article comprises a substrate having a coating. The coating comprises a surface-modified nanoparticle component having quaternary amine groups on the surface of the nanoparticles. The coated article comprises a coating containing quaternary amine groups as antistatic agents attached to the surface of a nanoparticle. More specifically, quaternary amine groups are covalently attached to the nanoparticle surface in a quantity sufficient to form a monolayer or less than a monolayer of coverage.

In one aspect of the disclosure, the coating further comprises a binder in which the nanoparticles are dispersed.

Quaternary amine groups present on the nanoparticle surface provide antistatic properties. In one aspect, the substrate is coated with a coating composition where the nanoparticles are dispersed further in a solvent. The quaternary amine groups of the coating dissipate static yielding surface resistivity measurements equal to or greater than 1×10⁵ Ω/sq, but less than 1×10¹² Ω/sq.

Static decay is determined when a charge is administered to a coated article, and the time in seconds for the charge to decay to 10% of its initial value is recorded. No measurable charge decay indicates that the article does not dissipate static or charge readily. The numerical static decay value in seconds is indicative of the static dissipative properties of the coating on the substrate in this disclosure.

In an embodiment of this disclosure, the nanoparticle component additionally comprises a mixture of amine groups of the surface of the nanoparticle including primary amines, secondary amines, and tertiary amines.

The substrate for the article of this disclosure provides a medium for a coating. Typically, insulating or non-conductive materials are suitable for topical treatment or surface coating. These materials have relatively low surface and bulk conductivity, and are prone to static charge buildup. Such materials include both synthetic and naturally-occurring polymers (or the reactive precursors thereof, for example, mono- or multifunctional monomers or oligomers) that can be either organic or inorganic in nature, as well are ceramics, glasses, and ceramers (or the reactive precursors thereof).

Suitable synthetic polymers for the substrate, either thermoplastic or thermoset, include commodity polymers such as poly(vinyl chloride), polyethylenes (high density, low density, very low density), polypropylene, and polystyrene; engineering plastics such as, for example, polyesters (including, for example, poly(ethylene terephthalate) and poly(butylenes terephthalate)), polyamides (aliphatic, amorphous, aromatic), polycarbonates (for example, aromatic polycarbonates such as those derived from bisphenol A), polyoxymethylenes, polyacrylate and polymethacrylates (for example, poly(methyl methacrylate)), some modified polystyrenes (for example, styrene-acrylonitrile (SAN) and acrylonitrile-butadiene-styrene (ABS) copolymers), high-impact polystyrenes (SB), fluoroplastics, and blends such as poly(phenylene oxide)-polystyrene and polycarbonate-ABS; high-performance plastics such as, for example, liquid crystalline polymers (LCPs), polyetherketone (PEEK), polysulfones, polyimides, and polyetherimides; thermosets such as, for example, alkyd resins, phenolic resins, amino resins (for example, melamine and urea resins), epoxy resins, unsaturated polyesters (including so-called vinyl esters), polyurethanes, allyllics (for example, polymers derived from allyldiglycolcarbonate), fluoroelastomers, and polyacrylates; and the like and blends thereof. Suitable naturally occurring polymers include proteinaceous materials such as silk, wool, and leather; and cellulosic material such as cotton and wood.

In one aspect, the static dissipative article comprises a substrate selected from the group consisting or molded materials, melt-blown materials, films, wovens, nonwovens, foams, and combinations thereof.

Surface preparation of a substrate may be performed before the application of a coating. The performance of a coating can be significantly influenced by the ability to adhere properly to the substrate material. The presence of surface contaminants, oil, grease, and oxides can physically impair and reduce coating adhesion to the substrate. The substrate can be surface treated or cleaned to improve the adhesion of the coating to a substrate.

In one embodiment of this disclosure, the substrate may be surface treated. Methods of surface treatment include vacuum deposition, corona, laser, chemical, thermal, flame, plasma, ozone, and combinations thereof.

The coating for the substrate of the static dissipative article provides for static dissipation. The coating composition comprises a surface-functionalized nanoparticle component having quaternary amine groups on the surface of the nanoparticle. The nanoparticles are dispersed in a binder, where the nanoparticles are essentially free of agglomeration. In one aspect, the coating composition comprises a solvent.

The nanoparticles are inorganic, having quaternary amine groups on the surface. The surface-modified nanoparticles further comprise primary, secondary, and tertiary amine groups. Further, the surface-modified nanoparticles can be dried, and readily dispersed in solvent of the coating composition.

Suitable inorganic nanoparticles include silica and metal oxide nanoparticles including zirconia, titania, ceria, alumina, iron oxide, vanadia, antimony oxide, tin oxide, alumina/silica, iron oxide/titania, titania/zinc oxide, zirconia/silica, calcium phosphate, nickel oxide, zinc oxide, calcium hydroxylapatite, and combinations thereof. In one aspect of the invention, the nanoparticles preferably have an average particle diameter less than 100 nm, preferably no greater than about 50 nm, more preferably from about 3 nm to about 50 nm, even more preferably from about 3 nm to about 20 nm, most preferably from about 5 nm to about 10 nm. If the nanoparticles are aggregated, the maximum cross sectional dimension of the aggregated particle is within any of these preferable ranges.

Metal oxide colloidal dispersions include colloidal zirconium oxide, suitable examples of which are describe in U.S. Pat. No. 5,037,579 (Matchett). Further, colloidal titanium oxide examples may be fount in WO 00/06495 (Amey et. al.). Inorganic colloid dispersions are available from Nyacol NanoTechnologies (Andover, Mass.).

In an exemplary embodiment, the unmodified silica particles may be used as the nanoparticle component of this disclosure. The nanoparticles may be in the form of a colloidal dispersion available under the produce designations NALCO 2326, 2327, 1130, 2359 (Nalco Chemical Company; Naperville, Ill.).

In another aspect, the nanoparticles are substantially individual, unassociated (i.e. non-aggregated), and dispersed without irreversible association. The term “associate with” or “associating with” includes, for example, covalent bonding, hydrogen bonding, electrostatic attraction, London forces, and hydrophobic interactions.

The nanoparticle component of this disclosure is surface-modified by the method described herein. The surface of the nanoparticle component may be modified with one or more amine surface modifying groups. A surface-modified nanoparticle is a particle that includes surface groups attached to the surface of the particle. The surface groups modify the hydrophobic or hydrophilic nature of the particle, including, but not limited to electrical, chemical, and/or physical properties. In some embodiments, the surface groups may render the nanoparticles more hydrophobic. In some embodiments, the surface groups may render the nanoparticles more hydrophilic. The surface groups may be selected to provide a statistically averaged, randomly surface-modified particle. In some embodiments, the surface groups are present in an amount sufficient to form a monolayer, preferably a continuous monolayer, on the surface of the particle.

In some situations where the nanoparticle is processed in solvent, the amine surface modifying groups may compatibilize the particle with the solvent for processing. In those situations, where the nanoparticles are not processed in solvent, the surface modifying group or moiety may be capable of preventing irreversible agglomeration of the nanoparticle.

In an exemplary embodiment of this disclosure, less than 80 percent of the available surface functional groups (e.g. Si—OH groups) of the nanoparticle are modified with a hydrophilic surface-modifying agent to retain hydrophilicity and dispersibility.

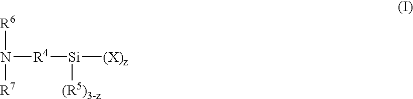

The aminoorganosilane as illustrated in formula (I) of this disclosure is referred to as a surface modifying agent. The surface modifying agent has at least two reactive functionalities. One of the reactive functionalities is capable of covalently bonding to the surface of the nanoparticles, and the second functionality is capable of being alkylated to form alkylamine groups. For example, if the nanoparticle is silica, the Si—OH groups of the nanoparticles are reactive with the X groups of the aminoorganosilane.

In one embodiment, for example, at least one X group is capable of reacting with the nanoparticle surface. In another aspect, the number of X groups ranges from 1 to 3, wherein further reaction of additional X groups may occur on the nanoparticle surface.

In an aspect of this disclosure, at least one aminoorganosilane, and more than one aminoorganosilane may be used for the surface modification, or in combination thereof.

The nanoparticle is surface-modified with aminoorganosilanes. The aminoorganosilane is of the formula (I). The aminoorganosilanes may comprise monoamine, diamine, and triamine functionality, wherein the amino groups may be within the chain or a terminal group. The aminoorganosilane is of the formula (I): wherein R⁶ and R⁷ are each independently hydrogen, linear or branched organic groups, alkyl groups having about 1 to about 16 carbon atoms (on average), aryl such as those selected from the group consisting of phenyl, thiophenyl, naphthyl, biphenyl, pyridyl, pyrimidinyl, pyrazyl, pyridazinyl, furyl, thienyl, pyrryl, quinolinyl, bipyridyl, and the like, alkaryl, such as tolyl, or aralkyl group, such as benzyl, and R⁶ and R⁷ may be attached by a cyclic ring, as represented by pyridine or pyrrole moiety; R⁴ is a divalent species, selected from linear or branched organic groups including alkyl having from 1 to 16 carbon atoms (on average), aryl, cycloalkyl, alkylether, alkylene (optionally including one or more caternary N (amine) groups in the chain or pendent, for example in formula (Ia) and combinations thereof;

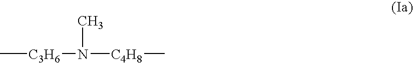

R⁵ is a independently selected from the group comprising alkyl, having from about 1 to about 16 carbon atoms (on average), aryl, and combinations thereof; X is a halide, alkoxy, acyloxy, hydroxyl and combinations thereof; and z is an integer from 1 to 3. Further, alkyl groups can be straight or branched chain, and alkyl and aryl groups can be substituted by noninterfering substituents that do not obstruct the functionality of the aminoorganosilane. The reaction mixture comprises at least one aminoorganosilane, but may comprise more than one aminoorganosilane, or combinations thereof.

The aminoorganosilane is used in amounts sufficient to react with 1 to 100% of the available functional groups on the inorganic nanoparticle (for example, the number of available hydroxyl functional groups on silica nanoparticles). The number of functional groups is experimentally determined where a quantity of nanoparticles is reacted with an excess of surface modifying agent so that all available reactive sites are functionalized with a surface modifying agent. Lower percentages of functionalization may then be calculated from the result. In an exemplary embodiment, the weight ratio of aminoorganosilane to nanoparticles ranges from 1.5:100 to 15:100.

The aminoorganosilanes are further selected from the group of aminoalkylsilanes, aminoarylsilanes, aminoalkoxysilanes, aminocycloalkylsilanes, and combinations thereof. The aminoorganosilane is present in the reaction mixture to functionalize at least 30 percent of the functional groups on the surface on the nanoparticle. Examples of aminoorganosilanes include 3-aminopropyltriethoxysilane, 3-aminopropyltrimethoxysilane, 4-aminobutyltriethoxysilane, m-aminophenyltrimethoxysilane, p-aminophenyltrimethoxysilane, aminophenyltrimethoxysilane, 3-aminopropyltris(methoxyethoxyethoxy)silane, 2-(4-pyridylethyl)triethoxysilane, 2-(trimethoxysilylethyl)pyridine, N-(3-trimethoxysilylpropyl)pyrrole, 3-(m-aminophenoxy)propyltrimethoxysilane, aminopropylsilanetriol, 3-aminopropylmethyldiethoxysilane, 3-aminopropyldiisopropylethoxysilane, 3-aminopropyldimethylethoxysilane, N-(2-aminoethyl)-3-aminopropyltrimethoxysilane, N-(6-aminohexyl)aminomethyltrimethoxysilane, N-(6-aminohexyl)aminopropyltrimethoxysilane, N-(2-aminoethyl)-11-aminoundecyltrimethoxysilane, (aminoethylaminomethyl)phenethyltrimethoxysilane, N-3-[(amino(polypropylenoxy)]aminopropyltrimethoxysilane, N-(2-aminoethyl)-3-aminopropylsilanetriol, N-(2-aminoethyl)-3-aminopropylmethyldimethoxysilane, N-(2-aminoethyl)-3-aminoisobutylmethyldimethoxysilane, (aminoethylamino)-3-isobutyldimethylmethoxysilane, (3-trimethoxysilylpropyl)diethylenetriamine, n-butylaminopropyltrimethoxysilane, N-ethylaminoisoburyltrimethoxysilane, N-methylaminopropyltrimethoxysilane, N-phenylaminopropyltrimethoxysilane, 3-(N-allylamino)propyltrimethoxysilane, N-cyclohexylaminopropyltrimethoxysi lane, N-phenylaminomethyltriethoxysilane, N-methylaminopropylmethyldimethoxysilane, bis(2-hydroxyethyl)-3-aminopropyltriethoxysilane, diethylaminomethyltriethoxysilane, (N,N-diethyl-3-aminopropyl)trimethoxysilane, 3-(N—N-dimethylaminopropyl)trimethoxysilane, and combinations thereof.

In an exemplary embodiment, 3-(N,N-dimethyl aminopropyl)trimethoxysilane may be used to modify the surface of the nanoparticles.

The alkylating agent reacts via a nucleophilic substitution reaction with the amino group of the aminoorganosilane coupled to the nanoparticle to form an alkylamines and quaternary ammonium salts. The alkylating agent is of the formula (II):

Y—R⁸-Z (II)

wherein Y may be hydrogen, fluorine, hydroxyl, allyl, vinyl ether or combinations thereof, or other groups which do not interfere with the alkylation of the amino group; R⁸ is a divalent species, selected from aliphatic (C₁ to C₂₄), cycloaliphatic, benzyl groups, alkylene (to include one or more caternary N (amine groups in the chain or pendent) or combinations thereof; and Z is a halide, tosylate, sulfate, functionalized sulfonates (e.g. 2-acrylamido-2-methyl-1-propanesulfonic acid), phosphate, hydroxyl group, or combinations thereof. The nucleophilic N of the aminoorganosilane attacks the electrophilic C of Y—R⁸-Z to displace Z. A new bond between N and the electrophilic C of Y—R⁸ is formed, thus forming the alkylated species of the quaternary amine group. The Z group, which is the leaving group of the alkylation reaction, forms the anion species of the quaternary ammonium salt as illustrated in formula (III).

Alkylation of amino groups with smaller alkyl halides generally proceeds from a primary amine to a quaternary amine. Selective alkylation may be accomplished by steric crowding on the amino group, which may reduce its nucleophilicity during alkylation. If the reacting amine is tertiary, a quaternary ammonium cation may result. Quaternary ammonium salts can be prepared by this route with diverse Y—R⁸ groups and many halide and pseudohalide anions.

In an exemplary embodiment, alkyl iodides, and alkyl bromides may be used to alkylate the aminoorganosilane.

In a further embodiment, the alkylating agent is an alkyl halide, for example, butyl bromide or lauryl chloride.

The amine group can be further alkylated to comprise a distribution of primary, secondary, tertiary, and quaternary amine groups forming a continuous monolayer coverage, or less than a monolayer of alkylamine and quaternary amine functionalization on the surface of the nanoparticle.

The quaternary amine of formula (III) is an ionic species, where Z⁻ is an anionic counterion to the cation, N⁺, of the quaternary ammonium group. The quaternary ammonium group is covalently bonded to the nanoparticle, ◯, at group X, where z=1-3. The reaction mixture contains at least one alkylating agent, but may also comprise more than one alkylating agent or combinations thereof.

It is understood that the X group attached to the silanes may further react with other silanes to form siloxanes, and/or react with other functional groups on the same or another nanoparticles. For example, formula (IIIa and IIIb) illustrate two possible reactions of the X groups representing attachment. Other reactions with the X group may be considered.

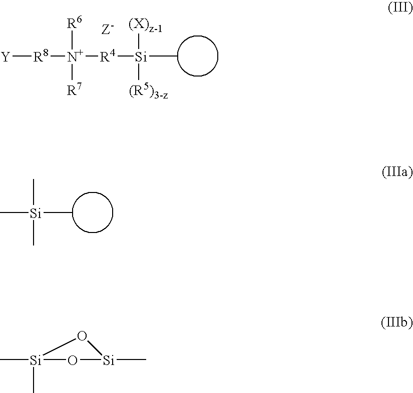

In an exemplary embodiment, the aminoorganosilane functionalized nanoparticles of this disclosure are further reacted with an alkylating agent. In a one-pot synthesis, the alkylating agent reacts react with the amino groups of the organosilane coupled to the nanoparticle.

In an exemplary embodiment, the alkyl halides react with the amines to form an alkyl-substituted amine followed by subsequent surface modification of the nanoparticles.

In an exemplary embodiment, the molar ratio of alkylating agent to aminoorganosilane ranges from 5:1 to 1:15. The amount of alkylating agent in the mixture is sufficient to quaternize the amino groups or alkylate at least a portion of the amino groups of the aminoorganosilane.

The surface-modified nanoparticles comprising alkylamine and quaternary amine groups are preferably individual, unassociated (non-aggregated) nanoparticles dispersed within the solvent or combination of solvents, where the nanoparticles do not irreversibly associate with each other. The surface-modified nanoparticles are dispersed within a solvent(s) such that the particles are free of particle agglomeration or aggregation.

The method of this disclosure further describes surface-modified nanoparticles comprising a monolayer of amine groups. The nanoparticle component may have surface modification or functionalization from a monolayer coverage to less than a monolayer coverage. The amine groups of the surface modification may comprise a distribution of primary, secondary, tertiary and quaternary amine groups. In a exemplary embodiment, the ratio of quaternary amine to tertiary amine groups ranges from 1:100 to 100:1 on the surface of the nanoparticle.

In an exemplary embodiment, the method of this disclosure can be further described wherein the surface functionalization of the nanoparticle is a continuous monolayer of alkylamine surface modified groups.

The reaction mixture of this disclosure contains a solvent or solvents for the dispersion of the nanoparticle component. Solvents useful for making surface-modified nanoparticles include water; alcohols selected from ethanol, propanol, methanol, 2-butoxy ethanol, 1-methoxy-2-propanol and combinations thereof; ketones selected from methyl ethyl ketone, methyl isobutyl ketone, acetone and combinations thereof; glycols selected from ethylene glycol, propylene glycol; dimethylformamide, dimethylsulfoxide, tetrahydrofuran, 1,4-dioxane, acetonitrile and combinations thereof. In the one-pot synthesis, polar solvents are used to disperse the unmodified nanoparticles and surface modified nanoparticles. The solvents in the one pot synthesis during surface modification of the nanoparticles disperse the particles. The alkylamine and/or quaternary amine surface groups of the nanoparticles provide for compatibility, such as solubility or miscibility.

In another embodiment of this disclosure, dried surface-modified nanoparticles are readily dispersible in solvent(s) and free of particle agglomeration and aggregation. The addition of solvents to dried surface-modified nanoparticles provides for a transparent mixture upon redispersion. Microscopy demonstrates individual particles dispersed within the solvent.

The hydrophilic surface groups, such as alkyl amines, covalently attached to a nanoparticle are re-dispersible in a solvent or in a combination of solvents. The dispersion of the surface-modified nanoparticles of this disclosure in a solvent ranges from 10 to 50 weight percent solids. In another aspect, the dispersion of the nanoparticles ranges from 15 to 40 weight percent solids. In a further aspect, the dispersion of the nanoparticles ranges from 15 to 25 weight percent solids.

Re-dispersed nanoparticles in solvents with reduced dispersibility yield hazy or cloudy solutions. Additionally, nanoparticles dispersed in a solvent with lower dispersibility can yield higher solution viscosities. The compatibility (e.g. miscibility) of dispersed surface modified particles in a solvent can be influenced factors such as the amount of surface modification on the nanoparticle, compatibility of the functional group on the nanoparticle with the solvent, steric crowding of the group on the particle, ionic interactions, and nanoparticle size, not to be all inclusive.

In another embodiment of this disclosure, the nanoparticles are surface modified with alkylamines, further comprising quaternary amine groups. Functionalization of the surface of the nanoparticle with an aminoorganosilane and alkylating the amino group to generate a quaternary amine group in a one-pot reaction can contribute to increased dispersibility in a solvent. Functionalization of the surface of the nanoparticle with a quaternary aminosilane, synthesized separately from the nanoparticle in a multi-step procedure contributes to lower dispersibility in a solvent. Reduced dispersibility of a nanoparticle from the multi-step procedure may be attributed to lower particle functionalization, steric crowding of functional groups, availability of functional groups from the silane to the nanoparticle, and the solubility of the quaternary aminosilane with the dispersed nanoparticle in a solvent. These factors or a combination of factors, not to be all inclusive, may be attributed to lower dispersibility.

The surface modified nanoparticles have surface amine groups that aid in the dispersion of the nanoparticle in solvents. The alkylamine and quaternary amine surface groups are present on the surface sufficient to provide nanoparticles that are capable of being dispersed without aggregation. The surface groups preferably are present in an amount sufficient to form a monolayer, preferably a continuous monolayer on the surface of the nanoparticle.

In one embodiment, the alkylamines and quaternary amines are represented by the formulas where e.g., —N(R⁶)₂ (primary); —N(R⁶R⁷) (secondary); —N(R⁷)₂ (tertiary); and —N((R⁷)₂YR⁸))⁺Z⁻ (quaternary), where R⁶ and R⁷ are each independently hydrogen, linear or branched organic groups, alkyl groups having about 1 to about 16 carbon atoms (on average), aryl such as those selected from the group consisting of phenyl, thiophenyl, naphthyl, biphenyl, pyridyl, pyrimidinyl, pyrazyl, pyridazinyl, furyl, thienyl, pyrryl, quinolinyl, bipyridyl, and the like, alkaryl, such as tolyl, or aralkyl group, such as benzyl, and R⁶ and R⁷ may be attached by a cyclic ring, as represented by pyridine or pyrrole moiety, R⁸ is a divalent species, selected from aliphatic (C₁ to C₂₄), cycloaliphatic, benzyl groups, alkylene (to include one or more caternary N (amine groups in the chain or pendent) or combinations thereof, Y can be hydrogen, fluorine, hydroxyl, allyl, vinyl ether, and combinations thereof, and Z is an ionic species from the alkylation reaction of the amine. The amine surface groups represent a distribution of amine group functionalities on the surface of nanoparticles.

In an exemplary embodiment, alcohols, water and combinations thereof are used as the solvent for making surface-modified nanoparticles.

In an exemplary embodiment, the mixture is agitated and heated at a temperature sufficient to ensure mixing and reaction of the mixture with the nanoparticles ranging from 1.5 to 28 hours. The unmodified nanoparticle component is dispersed in water. The aminoorganosilane, and an alkylating agent are added with a solvent to comprise the reaction mixture. After surface-modifying the nanoparticle component, the surface modified nanoparticles are analyzed for amine group composition.

Agitation of the reaction mixture can be obtained by shaking, stirring, vibration, ultrasound, and combinations thereof.

The temperature of modifying the surface of the nanoparticles is sufficient for the one pot synthesis (one-pot reaction) to occur. In one aspect, the reaction temperature ranges from 80° C. to 110° C.

In an exemplary embodiment of this disclosure, the surface-modified nanoparticles may be dried for 2 to 24 hours from 80° C. to 160° C. to remove solvent, water, and unreacted components. Solvent washing may be accomplished to further purify the nanoparticles of this disclosure.

Heating of the reaction mixture and drying the surface-modified nanoparticles can be obtained by thermal, microwave, electrical, and combinations thereof.

The coating composition of this disclosure comprises less than 25 weight percent surface modified nanoparticles. In another aspect, the composition comprises less than 10 weight percent nanoparticles. In a further aspect, the composition comprises less than 1 weight percent nanoparticles.

In another aspect, the coating composition comprises a solvent to provide for a dispersion of surface modified nanoparticles. Solvents useful for dispersing surface-modified nanoparticles in a coating composition include water, alcohols selected from ethanol, propanol, methanol, 2-butoxy ethanol, 1-methoxy-2-propanol and combinations thereof; tetrahydrofuran, acetone, acetonitrile and combinations thereof.

In one aspect, the surface-functionalized nanoparticles may be dispersed in a solvent and coated onto a substrate. The nanoparticles remain on the substrate after removal of the solvent providing for a static dissipative article. Further, the nanoparticle coating may perform as an intermediate layer in a multi-layer coating composition. The nanoparticle layer may be laminated or over-coated with another layer or coating.

In one embodiment, polymeric materials as binders, which may be thermoplastics or thermosets, for the coating composition of this disclosure include (meth)acrylates, acrylates, epoxies, polyols, isocyanates, styrenes, urethanes, amides, oxymethylenes, and combinations thereof. Other suitable binders which are soluble in water/alcohol or polar solvent systems can be contemplated. In one example, binders may be added to the coating composition to provide for durability of the coating surface, with the nanoparticles distributed throughout the coating.

In one embodiment, the concentration of the surface-functionalized nanoparticles is less than 10 weight percent of the coating composition.

In another embodiment, the composition comprises at least 20 weight percent binder in a solvent containing coating composition.

Generally, the coating solutions of the disclosure may further comprise materials that are solids at the coating conditions. These materials may include, e.g., organic and inorganic fillers (e.g., particles and fibers), clays, silicas, antioxidants, microspheres (e.g., glass and polymeric microspheres), dyes, pigments, resins, polymers, and combinations thereof.

In one aspect, the coating solution may further comprise other additives, including for examples, curing agents, initiators, accelerators, crosslinking agents, surface active agents, and combinations thereof.

The coating compositions or coating solutions of this disclosure may be used to coat substrates. In some embodiments, the solution may be prepared by, for example, mixing or blending at least one binder, the surface-modified nanoparticles, and any optional materials. Any known mixing and/or blending equipment or techniques, including e.g., stirring, shaking, high-shear and low-shear mixing may be used. In some embodiments, the coating solution appears homogeneous after mixing.

In one embodiment, the coating of this disclosure comprises surface-functionalized nanoparticles having quaternary amine groups on the surface of the nanoparticle dispersed with a binder. The binder selection may contribute to the dispersibility of the surface-functionalized nanoparticles. In one instance, the binder and the nanoparticles may agglomerate and gel due to incompatibility. In another instance, the binder and nanoparticles may be compatible where the nanoparticles are dispersed within the binder.

The dispersibility of the nanoparticles in a binder for a coating composition may influence the coatings performance. An agglomerated coating may be difficult to coat on a substrate, and provide for a coated article with reduced or negligible static dissipative properties. A compatible coating composition with nanoparticles dispersed within a resin coated on a substrate provide for an article with static dissipative properties.

In one embodiment, a compatible binder and nanoparticles of a coating composition provide for a static dissipative article.

In this disclosure, the coating solution is then applied to the surface of the substrate. Coating methods known in the art may be used to include roll coating, curtain coating, bar coating, spraying, dipping, padding and other modification or combinations of applications. At least one liquid is removed from the coated solution and a film is formed on the surface of the substrate. In some embodiments, the liquid is removed by evaporation.

The coated substrate may harden or toughen after application to the substrate. In one aspect, the solvent is removed from the coating and a film is formed on the surface of the substrate by curing without crosslinking the binder. In some embodiments, the solvent is removed by evaporation. In another aspect, the one or more of the coated materials may be cured (crosslinked) by e.g., heat actinic radiation (e.g., infrared, visible, or ultraviolet light, and combinations thereof), electron beam, moisture, and combinations thereof.

In one aspect, the applied coating on the substrate is sufficiently thick to form a substantially continuous antistatic coating composition on a substrate. The wet coating thickness is less than 400 μm. In another aspect, the wet coating thickness is less than 250 μm. As described, curing of the coating, either by solvent evaporation or crosslinking of the polymer chains of the binder can result in a reduced film thickness.

In an exemplary embodiment, the substrate can be coated by the roll coating method.

In a further embodiment, the cured or dried coating thickness of the static dissipative article is less than 100 μm. In one embodiment, the cured or dried coating thickness is less than 75 μm, and in a further embodiment, less than 40 μm, sufficient to render the article static dissipative.

Objects and advantages of this disclosure are further illustrated by the following examples. The particular materials and amounts thereof, as well as other conditions and details, recited in these examples should not be used to unduly limit this disclosure.

### EXAMPLES

All solvents and reagents were obtained from Sigma-Aldrich Chemical Company, Milwaukee, Wis., unless otherwise noted. Nalco 2326 colloidal silica was obtained from Nalco Chemical Company, Bedford Park, Ill. Biaxially oriented polypropylene film (BOPP) was available from Toray Plastics (America) Inc. North Kingstown, R.I. under the trade name TREAX-TX-G. NeoRez R960, NeoRez XK-90, and Neocryl CX-100 were obtained from Avecia Limited, Manchester, United Kingdom. All percents and amounts are by weight unless otherwise specified.

Nuclear Magnetic Resonance spectroscopic analysis was carried out using a 400 MHz Varian NOVA solid-state spectrometer (Palo Alto, Calif.). Samples were packed in 5 mm rotors. ¹⁵N and ¹³C CP/MAS were collected using a 5 mm MAS NMR probe. ¹⁵N spectra are referenced to liquid ammonia through a secondary reference of 15N labeled glycine. ¹³C spectra were referenced to TMS through a secondary reference of hexamethylbenzene. The quaternary peak at 55 ppm and the ternary peak at 45 ppm were used to determine the degree of quaternization.

The Surface Resistivity Test was conducted according to the procedure of ASTM Standard D-257: “D.C. Resistance or Conductance of Insulating Materials”. The surface resistivity was measured using an ETS Model 406C Surface Resistivity/Resistance Meter (Electro-Tech Systems, Inc., Glenside, Pa.). The surface resistivity was measured across the surface of a material in units given in “Ω/cm²”. All measurements were made with a 5 kV charge.

Static dissipation measurements were made using a static decay meter (Model 406C from Electro-Tech Systems, Inc., Glenside, Pa.). Sample for measurements were prepared by cutting approximately five inch square samples, and then mounting between the meter electrodes using magnets. The samples were charged to +/−5 kV, and the time (seconds) for the charge to decay to 10% of its initial value was measured and recorded.

The surface resistivity and static decay measurements of uncoated films or substrates were performed and recorded at 22° C., and approximately 27% relative humidity. The measured surface resistivity of the polyester films was greater than 1×10¹² Ω/cm², and there was no measurable charge decay of the BOPP films during the 10 second observation time.

### Preparative Example 1

A mixture of Nalco 2326 colloidal silica (100 g), N,N-dimethylaminopropyltrimethoxysilane (5.88 g; Gelest, Incorporated, Morrisville, Pa., USA) in a solvent mixture consisting of ethyl alcohol (90 g) and methyl alcohol (23 g) together were stirred in a three-neck round bottom flask equipped with a mechanical stirrer at 80° C. for 1 hour. Butyl bromide (3.88 g) in ethyl alcohol (10 g,) was added to this mixture, and stirred for an additional 18 hours at a temperature of 80° C. The product was isolated by drying in an oven at 130° C. (22.7 g). The surface-modified nanoparticles were soluble in water at greater than 20 weight percent yielding a solution without an observable increase in solution viscosity.

### Preparative Example 2

A mixture of Nalco 2326 colloidal silica (100 g), N,N-dimethylaminopropyltrimethoxysilane (8.12 g) in a solvent mixture consisting of ethyl alcohol (90 g,) and methyl alcohol (23 g) together were stirred in a three-neck round bottom flask equipped with a mechanical stirrer at 80° C. for 1 hour. Butyl bromide (5.37 g) in ethyl alcohol (10 g) was added to this mixture and stirred for an additional 18 hours while at a temperature of 80° C. The product was isolated by drying in an oven at 130° C. (25.8 g). The surface-modified nanoparticles were soluble in water at greater than 20 weight percent yielding a solution without an observable increase in solution viscosity.

### Preparative Example 3

A mixture of Nalco 2326 colloidal silica (100 g), N,N-dimethylaminopropyltrimethoxysilane (5.88 g), lauryl chloride (5.8 g) and methoxypropanol (112.5 g,) together were stirred in a three-neck round bottom flask equipped with a water cooled reflux condenser and mechanical stirrer at 80° C. for 19.5 hours. The product was isolated by drying in an oven at 150° C.

### Example 1

A coating composition or solution consisting of surface-modified nanoparticles of Preparative Example 1 (4 parts) in isopropanol/water (92/4 parts, respectively) was mixed in a glass jar for 18 hours at room temperature. The solution was then coated onto a polyester film using a Meyer bar #6 (RD Specialties, Webster, N.Y.) to yield a substrate with a wet coating thickness of approximately 14 μm. The coated film was dried in an oven at 130° C., for 1 hour prior to analysis. The surface resistivity of the coated film was determined to be 5.50 E+08 Ω/cm².

### Example 2

A coating composition or solution consisting of surface-modified nanoparticles of Preparative Example 2 (4 parts) in isopropanol/water (92/4 parts, respectively) was mixed in a glass jar for 18 hours at room temperature. This solution was then coated onto a polyester film using a wire bar coater Meyer bar #6 (RD Specialties, Webster, N.Y.) to yield a substrate with a wet coating thickness of approximately 14 μm. The coated film was dried in an oven at 130° C., for 1 hour prior to analysis. The surface resistivity of the coated film was determined to be 6.30 E+09 Ω/cm².

### Example 3

Surface modified nanoparticles of preparative example 3 (0.8 grams) were ground into a fine powder using a mortar and pestle. Part A—NeoRez R960 (1.25 grams) and part B—Neocryl CX-100 (1.25 grams) were added to the nanoparticles followed by mixing in a glass vial with water (2 ml) to form the coating composition. This mixture was shaken mechanically until it was homogenous, and immediately coated on to BOPP film (7×12 inch) using a Meyer bar #14 (RD Specialties, Webster, N.Y.) to yield a substrate with a wet coating thickness of approximately 20 μm. The coated BOPP sheets were dried in an oven at 55° C. for 5 minutes. Static dissipation measurements were made using a static decay meter (Model 406C from Electro-Tech Systems, Inc., Glenside, Pa.). Samples for measurement were prepared by cutting approximately five inch square samples, and mounting them between the meter electrodes using magnets. The samples were charged to +/−5 kV, and the time for the charge to decay to 10% of its initial value was recorded. The recorded results were 0.023 seconds (+), and 0.01 seconds (−).

### Example 4

Surface modified or functionalized nanoparticles of preparative example 3 (0.8 grams) were ground into a fine powder using a mortar and pestle. Part A—NeoRez XK-90 (1.25 grams) and part B—Neocryl CX-100 (1.25 grams) were added to the nanoparticles followed by mixing in a glass vial with water (2 ml) to form the coating composition. This mixture was shaken mechanically until it was homogenous, and immediately coated on to BOPP film (7×12 inch) using a Meyer bar #14 (RD Specialties, Webster, N.Y.) to yield a substrate with a wet coating thickness of approximately 20 μm. The coated BOPP sheets were dried in an oven at 55° C. for 5 minutes. Static dissipation measurements were made using a static decay meter (Model 406C from Electro-Tech Systems, Inc., Glenside, Pa.). Samples for measurements were prepared by cutting approximately five inch square samples, and mounting them between the meter electrodes using magnets. The samples were charged to +/−5 kV, and no measurable charge decay was noted during the observed time period of 10 seconds at either pole.

We claim:

1. A static dissipative article comprising a substrate having a coating, the coating comprising a surface-functionalized nanoparticle component having a quaternary amine groups on the surface of the nanoparticle.

2. The article of claim 1, wherein the coating further comprises a binder.

3. The article of claim 1, wherein the nanoparticles are selected from the group consisting of silica, titania, alumina, nickel oxide, zirconia, vanadia, ceria, iron oxide, antimony oxide, tin oxide, zinc oxide, alumina/silica, iron oxide/titania, titania/zinc oxide, zirconia/silica, calcium phosphate, calcium hydroxyapatite and combinations thereof.

4. The article of claim 2, wherein the binder is selected from the group consisting of polyolefins, polyester, polycarbonates, polyacrylates, poly(meth)acrylates, polystyrenes, cellulosics, and combinations thereof.

5. The article of claim 1, on which the quaternary amine groups are present on the surface of the nanoparticle in a quantity sufficient to form a monolayer of coverage to less than a monolayer coverage.

6. The article of claim 1, wherein the substrate is selected from the group consisting of thermoplastic polymers, thermoset polymers, cellulosic materials, glasses, ceramics, ceramers and combinations thereof.

7. The article of claim 6, wherein the substrate is further selected from the group consisting of molded materials, melt-blown materials, films, wovens, nonwovens, foams, and combinations thereof.

8. The article of claim 1, wherein the surface-functionalized nanoparticles comprise a mixture of —N(R⁶)₂ groups; —N(R⁶R⁷) groups; —N(R⁷)₂ groups; and —N((R⁷)₂YR₈))⁺Z⁻ groups represented by the formula: 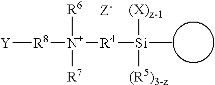
wherein R⁶ and R⁷ are each independently hydrogen, linear or branched organic groups and combinations thereof; R⁴ is a divalent species, selected from linear or branched organic groups and combinations thereof; R⁵ is independently selected from the group comprising alkyl, aryl, and combinations thereof; X is a halide, alkoxy, acyloxy, hydroxyl and combinations thereof; R⁸ is a divalent species, selected from aliphatic, cycloaliphatic, benzyl groups, alkylene and combinations thereof; Y is hydrogen, fluorine, hydroxyl, allyl, vinyl ether, and combinations thereof; Z is a halide, tosylate, sulfate, functionalized sulfonates, phosphate, hydroxyl group, and combinations thereof; and z is an integer from 1 to 3; thereof on the surface of the nanoparticle.

9. A coating composition comprising:
a) a surface-functionalized nanoparticle component having an quaternary amine groups on the surface of the nanoparticles; and
b) a binder in which the nanoparticles are dispersed.

10. The coating composition of claim 9, wherein the composition further comprises a solvent.

11. The coating composition of claim 9, wherein the concentration of the surface-functionalized nanoparticles is less than 25 weight percent.

12. The coating composition of claim 9, wherein the nanoparticles are essentially free of agglomeration.

13. The coating composition of claim 10, wherein the concentration of the binder is at least 20 percent.

14. A method for making a static dissipative article comprising:
a) providing a substrate;
b) providing a coating comprising:
i) a surface-functionalized nanoparticle component having a quaternary amine groups on the surface of the nanoparticles; and
ii) a binder in which the nanoparticles are dispersed; and
c) applying the coating onto the substrate.

15. A method of claim 14, further comprising the step of curing the coating on the substrate.

16. The article of claim 14, wherein the cured coating thickness is less than 100 μm.

17. The method of claim 14, wherein the substrate comprises a surface treated substrate.

18. The method of claim 17, wherein the surface treatment is selected from the group consisting of vacuum deposition, corona, laser, chemical, thermal, flame, plasma, ozone and combinations thereof.

19. A method for applying a coating comprising:
a) providing a coating comprising:
i) a surface-functionalized nanoparticle component having a quaternary amine groups on the surface of the nanoparticles; and
ii) a binder in which the nanoparticles are dispersed;
b) applying the coating onto a substrate; and
c) curing the coating on the substrate.
